(19) United States
(12) Patent Application Publication
(10) Pub. No.: US 2014/0257654 A1
(43) Pub. Date: Sep. 11, 2014

(54) SHIFT INDICATOR

(71) Applicant: Speedhut Inc., Orem, UT (US)

(72) Inventors: Jonathan Wade Snarr, Gunnison, UT (US); Aaron R. Westberg, Lindon, UT (US)

(73) Assignee: Speedhut Inc., Orem, UT (US)

(21) Appl. No.: 14/199,848

(22) Filed: Mar. 6, 2014

Related U.S. Application Data
(60) Provisional application No. 61/773,558, filed on Mar. 6, 2013.

(51) Int. Cl. F16H 61/02

(52) U.S. Cl. CPC F16H 61/0204
USPC 701/58

(57) ABSTRACT

A method and system for a shift indicator are provided. The method includes receiving a number of gears of a transmission of a vehicle, determining a plurality of average revolutions per minute (“RPM”) to vehicle speed ratios for each of the gears of the transmission, comparing a current RPM to vehicle speed ratio to the plurality of average RPM to vehicle speed ratios to determine a current gear, and based on the current gear and a current RPM, indicating to a driver of the vehicle to shift the vehicle to a new gear. The system includes components for implementing the method.

### CROSS-REFERENCE TO RELATED APPLICATIONS

This application claims the benefit of U.S. Provisional Patent Application No. 61/773,558 entitled “SHIFT INDICATOR” and filed on Mar. 6, 2013 for J. Wade Snarr et al., which is incorporated herein by reference.

### FIELD

The subject matter disclosed herein relates to instruments, and more particularly relates to indicators for vehicles.

### BACKGROUND

Vehicles continue to improve in efficiency and performance. One important part of maximizing efficiency and performance is to optimize shifting points of a transmission. The shifting point may vary depending on whether a driver wants to maximize efficiency or performance. Because each motor delivers peak horsepower at different RPMs, the shift point for maximum performance may vary with each motor. If the vehicle has a manual transmission, or an automatic transmission with a manual mode, the driver of the vehicle is responsible for shifting within the proper range of RPMs. A racer, for example, tries to shift gears within a range of RPMs that correlates to the peak horsepower.

Performance is not maximized when the driver shifts gears outside of this maximum engine power range. Driver error is usually the reason why a vehicle is shifted outside of the maximum engine power range, when performance is desired. Similarly, if maximum efficiency is desired, the driver may often shift the gears of the vehicle outside of a maximum engine efficiency range.

### BRIEF SUMMARY

A method and system for a shift indicator are provided. The method includes receiving a number of gears of a transmission of a vehicle, determining a plurality of average revolutions per minute (“RPM”) to vehicle speed ratios for each of the gears of the transmission, comparing a current RPM to vehicle speed ratio to the plurality of average RPM to vehicle speed ratios to determine a current gear, and based on the current gear and a current RPM, indicating to a driver of the vehicle to shift the vehicle to a new gear.

The method may include monitoring, for a time period, the RPM of a motor and the vehicle speed, and calculating the ratio of average RPM to average vehicle speed. In one embodiment, the time period is in the range of between about 1 and 10 seconds. In another embodiment, the time period is in the range of between about 3 and 7 seconds.

The method may also include receiving further comprises querying a vehicle engine control module for the number of gear, or alternatively, receiving the number of gears from a user. In one embodiment, the method includes receiving the current RPM via an on-board diagnostic interface. The system includes components for implementing the method.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a perspective diagram illustrating one embodiment of a shift indicator in accordance with embodiments of the present disclosure;

FIG. 2 is perspective view diagram illustrating another embodiment of the shift indicator according to embodiments of the present disclosure;

FIG. 3 is a block diagram illustrating a top view diagram of the shift indicator in accordance with embodiments of the present disclosure;

FIG. 4 is a schematic block diagram illustrating one embodiment of the shift controller in accordance with embodiments of the present disclosure;

FIG. 5 is a flow chart diagram illustrating one embodiment of a method for indicating when a driver should shift gears in a vehicle in accordance with embodiments of the present disclosure; and

FIG. 6 is a diagram of one embodiment of a computer system for facilitating the execution of a shift indicator.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. One skilled in the relevant art will recognize, however, that the disclosure may be practiced without one or more of the specific details, or with other methods, components, materials, and so forth. In other instances, well-known structures, materials, or operations are not shown or described in detail to avoid obscuring aspects of the disclosure.

Described herein are methods and devices for indicating to a driver of a vehicle that the driver should shift the transmission of the vehicle from one gear to a second gear. Embodiments of the present disclosure provide a shift controller configured to analyze vehicle operating parameters to determine an average RPM to vehicle speed ratio for each gear of the transmission. By comparing a current RPM to vehicle speed ratio to a determined average ratio, the shift controller can identify a current gear and determine whether to indicate to the driver that the driver should shift gears based on a current RPM and a shift point for the identified gear.

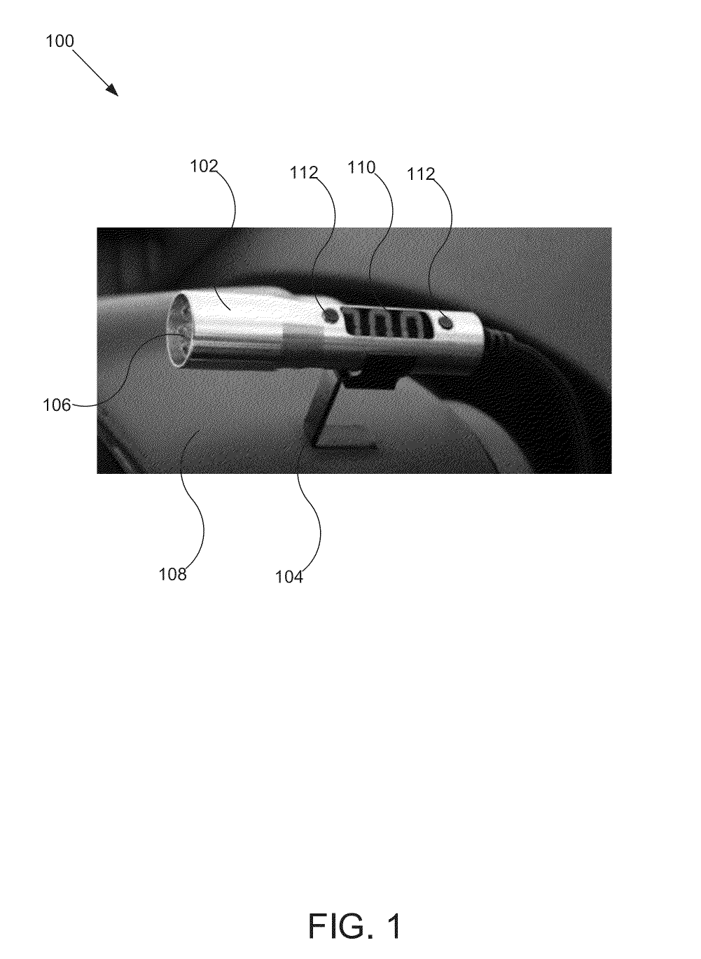

FIG. 1 is a perspective diagram illustrating one embodiment of a shift indicator in accordance with embodiments of the present disclosure. In the depicted embodiment, the shift indicator 100 is formed of a substantially tubular member 102. The tubular member 102 is mountable to an object via a mount 104. The tubular member 102 may be formed of a rigid material, for example, stainless steel. In another embodiment, the tubular member 102 may be formed of a rigid polymer. The tubular member 102 is given by way of example only, as the shift indicator 100 may be embodied as a container of any shape suitable for containing a controller, as will be described below.

In one embodiment, the mount 104 couples the tubular member 102 to the object via an adhesive member at one end. The adhesive member (not shown) may be a portion of, for example, double-sided adhesive tape. At a second end the mount 104 attaches to the tubular member 102 via a friction coupling as illustrated. In one embodiment, the object is a dash 108 of a vehicle. In an alternative embodiment, the mount 104 couples the tubular member 102 directly to a gauge. For example, the gauge may be a tachometer of the vehicle.

In one embodiment, the shift indicator 100 includes a visual indicator 106. The visual indicator 106 may comprise a grouping of light emitting diodes (LEDs), or in another embodiment, a single LED. In another embodiment, the visual indicator may be any other type of light emitting device with a brightness sufficient to indicate to the driver of the vehicle that the driver should shift a gear selector into another gear of the transmission. In another embodiment, the shift indicator 100 includes an aural indicator that functions in a manner similar to the visual indicator 106. In other words, the aural indicator may emit a sound of sufficient intensity to indicate to the driver that the driver should shift the vehicle.

The shift indicator 100 also includes a display 110 and at least one input device 112. The display 110, in one embodiment, is a seven segment LED digital display. In another embodiment, the display is a digital display capable of displaying information in a numerical or textual format including, but not limited to a liquid crystal display, a field emission display, a vacuum fluorescent display, a flip-dot display, etc. The input device 112 is configured to receive input from the driver of the vehicle. The types of input include configuration information and miscellaneous settings related to the shift indicator 100, as will be discussed below in greater detail.

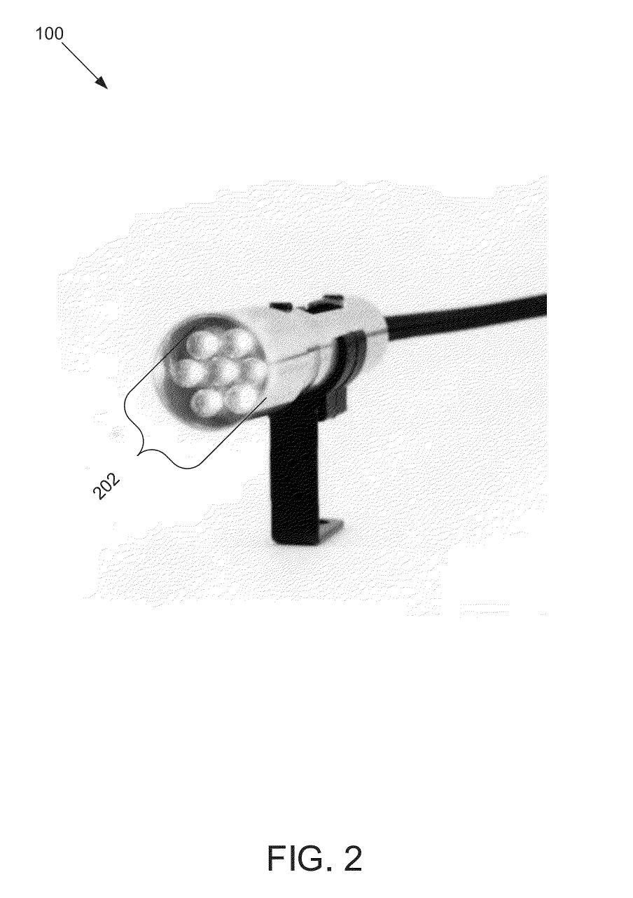

FIG. 2 is perspective view diagram illustrating another embodiment of the shift indicator 100 according to embodiments of the present disclosure. The shift indicator 100, as discussed above, may include an array of LEDs 202. The array of LEDs 202 may be configured to emit light at a predetermined wavelength. For example, the array of LEDs 202 may emit a blue wavelength, or in another embodiment, any wavelength determined to be capable of capturing the attention of the driver.

In another embodiment, the array of LEDs 202 may be implemented as a single LED, or other device capable of emitting light. The array of LEDs 202 may be configured to emit a light at a single, predetermined intensity. Alternatively, the array of LEDs 202 may be configured to emit a light that increases in intensity. In another embodiment, the array of LEDs 202 may be configured to blink at a constant frequency, or alternatively, at a varying frequency depending upon detected vehicle conditions as will be discussed in greater detail below.

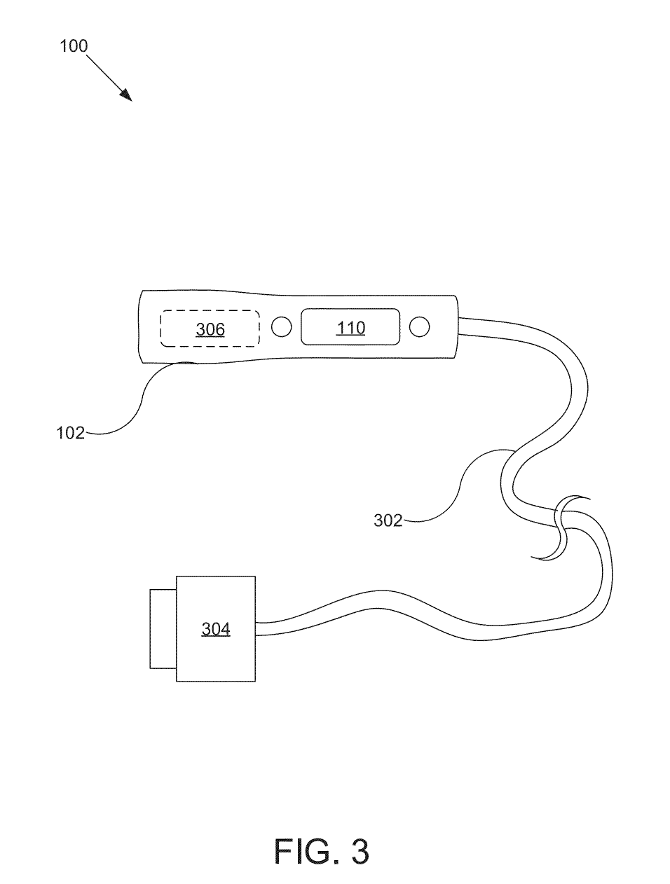

FIG. 3 is a block diagram illustrating a top view diagram of the shift indicator 100 in accordance with embodiments of the present disclosure. The shift indicator 100 includes, in one embodiment, a length of cable 302 coupling the tubular member 102 with a vehicle interface 304. The vehicle interface 304, in one embodiment, is an on-board diagnostic (“OBD”) interface. The vehicle interface 304 enables communication between a shift controller 306 and a vehicle engine control module (“ECM”). The shift controller 306 is configured to communicate over the vehicle interface 304 via any number of protocols, including but not limited to, controller area network (“CAN”) bus protocol, local interconnect network (“LIN”) serial protocol, etc.

The vehicle interface 304, via the cable 302, allows the shift controller 306 to communicate with the ECM of the vehicle. The shift controller 306 is configured to query the ECM and receive engine operating parameters from the ECM. Examples of engine operating parameters that may be used by the shift controller include, but are not limited to, speed of the vehicle, revolutions per minute (“RPM”) of the pistons in the engine, etc. The engine operating parameters are received, by the shift controller 306, in real-time. In other words, the shift controller constantly queries and receives current engine operating parameters. The shift controller may sample the engine operating parameters once a second. Alternatively, the shift controller may query the ECM any number of times per second. In a further embodiment, the number of queries per second may increase and/or decrease depending upon the engine operating parameters. For example, the shift controller may sample, or query the ECM, ten times a second for an RPM of about 1000, and increase the number of queries as the RPM of the engine increases.

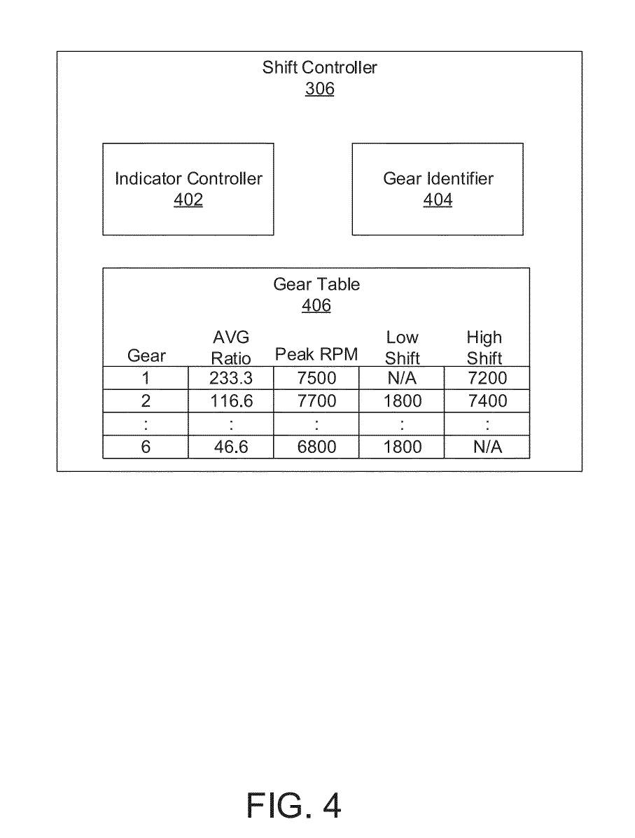

FIG. 4 is a schematic block diagram illustrating one embodiment of the shift controller 306 in accordance with embodiments of the present disclosure. The shift controller 306 is configured to operate in at least one of two modes: a first mode for generating vehicle specific information, and a second mode for normal operation. The first mode may be referred to as a programming mode for identifying how many gears a vehicle has and calculating an average ratio for each gear. In the second, or normal, mode the shift controller 306 monitors engine operating parameters to determine which gear the vehicle is currently engaging, and whether to indicate to the driver that the driver should shift gears.

The shift controller 306, in one embodiment, includes an indicator controller 402, a gear identifier 404, and a gear table 406. The indicator controller 402 is configured to activate the visual or aural indicators of the shift indicator 100. In one example, the indicator controller 402 activates the LED array 202 of FIG. 2 when the gear identifier 404 determines that the driver should shift the gears of the vehicle.

While operating in the programming, or first, mode the shift controller 306 is configured to receive information indicative of vehicle preferences. Examples of vehicle preferences include, but are not limited to, how many gears the vehicle has, and shift points for each gear. The term shift point, as used herein, refers to an RPM at which the driver should shift the gears of the vehicle. For example, a shift point may be an RPM at which the driver should shift from 1^{st} to 2^{nd} gear, or alternatively, from 2^{nd} to 1^{st} gear. As such, each gear may have an associated “low shift” point and a “high shift” point. The low shift point refers to an RPM at which the driver should down shift, and the high shift point refers to an RPM at which the driver should up shift. The low shift point of the 1^{st} gear, however, is not applicable because there is no gear lower than 1^{st} gear, however, the shift controller may be configured to indicate that the driver should shift to neutral or the car will stall. In a similar manner, the high shift point of the highest gear may indicate an “over-rev” limit. Stated differently, the shift indicator 306 may highest maintain a high shift value for 6^{th} gear that indicates a potential failure point (i.e., potential for the motor to fail).

The shift points may be predetermined according to vehicle or engine type and stored in the gear table 406. The gear table 406, in one embodiment, is a lookup table maintained by the shift controller 306. In an alternative embodiment, the gear table 406 is a data structure stored in memory accessible by the shift controller 306. The gear table 406 may be pre-populated with vehicle specific preferences based on information received from the ECM of the vehicle. In another embodiment, the shift controller 306 receives the vehicle preferences from the driver of the vehicle via the input devices 112 of FIG. 1. For example, the input device 112 may be a depressible button that when depressed, indicates vehicle preferences to the shift controller 306.

In one embodiment, the driver of the vehicle may press the input device 112 to indicate a shift point RPM (high or low) for a particular gear. In another embodiment, the shift controller 306 causes the display 110 to display a numeric value which the driver may increase or decrease using the input devices 112. While in the programming mode, the shift indicator 306 may cause the display 110 of FIG. 1 to display a number of gears for the vehicle, which the driver may increase or decrease to match the number of gears of the transmission. The shift controller 306 may then receive the shift points for each of the gears. The shift controller 306 may receive an RPM in the manner described above with reference to the number of gears, or alternatively, the shift controller 306 may receive an indication of a button press of the input device 112 and record the current RPM of the engine as the shift point for a particular gear.

The shift controller 306 is also configured to calculate an average ratio for each gear and maintain the average ratio in the gear table 406. In one embodiment, the average ratio is a ratio of RPM to vehicle speed. For example, the shift controller 306 may determine, during the programming mode, that the average ratio of 1^{st} gear is 3500 RPM/15 MPH, or 233.3. These specific numbers are given by way of example only, and are not intended to be limiting. The average ratio is vehicle and engine specific, and may change with every modification that is performed on the vehicle. For example, if the size or weight of tires is changed, or a different octane fuel is used, etc. In one embodiment, the shift controller 306 analyzes each gear for a predetermined period of time in the range of between about 1 and 10 seconds. In another embodiment, the shift controller 306 analyzes the ratio of RPM to vehicle speed for a period of about 5 seconds. After each period of time, the shift controller 306 indicates to the driver that programming for that specific gear is finished, and the driver should shift gears to continue programming for the next gear. After each gear has been analyzed by the shift controller 306, the shift controller 306 is configured to indicate to the driver that programming is finished.

The shift controller 306, while operating in the normal mode, is configured to monitor the RPM of the vehicle and maintain a peak RPM for each gear. The peak RPM refers to the maximum RPM of the engine while in a particular gear. For example, the peak RPM of the engine while in 1^{st} gear may be 7500 RPM. The shift controller 306 is configured to identify when the engine RPM exceeds the peak RPM and record the new maximum RPM as the peak RPM. The shift controller 306 is also configured to display the peak RPM when requested by the driver via the input device 112.

The gear identifier 404 is configured to identify the current gear of the vehicle while being driven, and determine if the driver should shift the gear of the vehicle. In one embodiment, the gear identifier 404 compares a current RPM to vehicle speed ratio to the average ratios in the gear table to determine which gear is the current gear. The gear identifier 404 makes this determination, in one embodiment, by taking the difference between the current ratio and the different average ratios in the gear table 406. The gear identifier 404 determines which gear is the current gear by identifying the gear with the smallest difference between the current ratio and the average ratios. For example, if the current ratio is approximately 51, the gear identifier 404 calculates the difference between 51 and the different average ratios and determines that the vehicle is in 6^{th} gear. The gear identifier 404 is also configured to monitor the current RPM and compare the current RPM to the high and/or low shift points for the current gear. If the current RPM exceeds the high and/or low shift points, the gear identifier 404 activates the indicator controller 402 to indicate to the driver that the driver should up or down shift.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

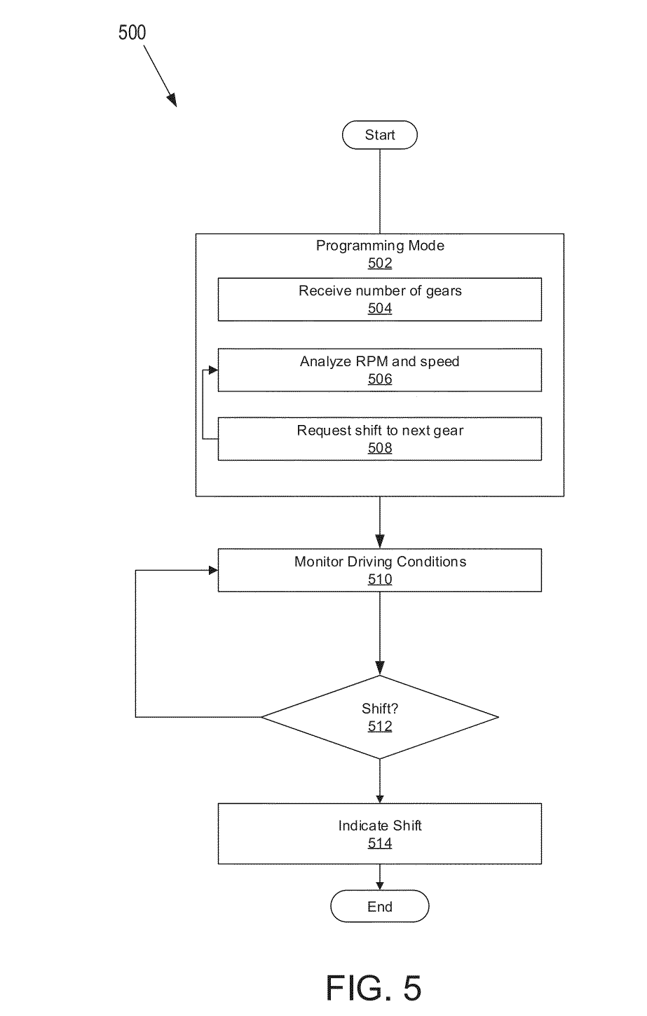

FIG. 5 is a flow chart diagram illustrating one embodiment of a method 500 for indicating when a driver should shift gears in a vehicle in accordance with embodiments of the present disclosure. The method is performed by processing logic that may comprise hardware (circuitry, dedicated logic, etc.), software (such as is run on a general purpose computer system or a dedicated machine), or a combination of both. In one embodiment, the method is performed by the shift controller (e.g., shift controller 306 of FIG. 4).

The method 500 starts and the processing logic, at block 502, initiates a programming mode which, in one embodiment, includes the steps 504, 506, 508 of receiving a number of gears, analyzing RPM and vehicle speed, and requesting a shift to the next gear. The processing logic, at block 504, receives the number of gears of the vehicle. In one example, the processing logic receives the number of gears of the vehicle by querying the ECM of the vehicle. In an alternative embodiment, the processing logic receives the number of gears from the driver of the vehicle via the input device 112.

At block 506, the processing logic analyzes RPM and vehicle speed of the first gear to determine an average ratio for the first gear. The average ratio is stored, for example in the gear table of FIG. 4. The processing logic then, at block 508, requests that the driver shift the gears to the second gear. This process of determining an average ratio is completed by the processing logic for each gear. In one embodiment, the processing logic monitors vehicle operating parameters for a time period of about 5 seconds to determine an average ratio. After completing the programming mode 502, the processing logic transitions to normal operating mode and, at block 510, monitors driving conditions.

At block 510, the processing logic monitors vehicle operating parameters including, but not limited to, current RPM and current vehicle speed. The processing logic monitors the vehicle operating parameters by querying the ECM via the OBD II interface as described above. The processing logic may query the ECM a predetermined number of times per second, or alternatively may increase or decrease the number of queries per second based on the current RPM to vehicle speed ratio.

At decision block 512, the processing logic determines whether to indicate to the driver that the driver should shift the vehicle. In one embodiment, the processing logic determines this by comparing the current RPM to vehicle speed ratio to the average ratios in the gear table. After identifying which gear the vehicle is in, the processing logic monitors the current RPM to determine if the current RPM exceeds the high or low shift point of the identified gear. If the current RPM exceeds the shift point, the processing logic, at block 514, indicates to the driver that the driver should shift the vehicle. The method 500 ends when the vehicle is turned off.

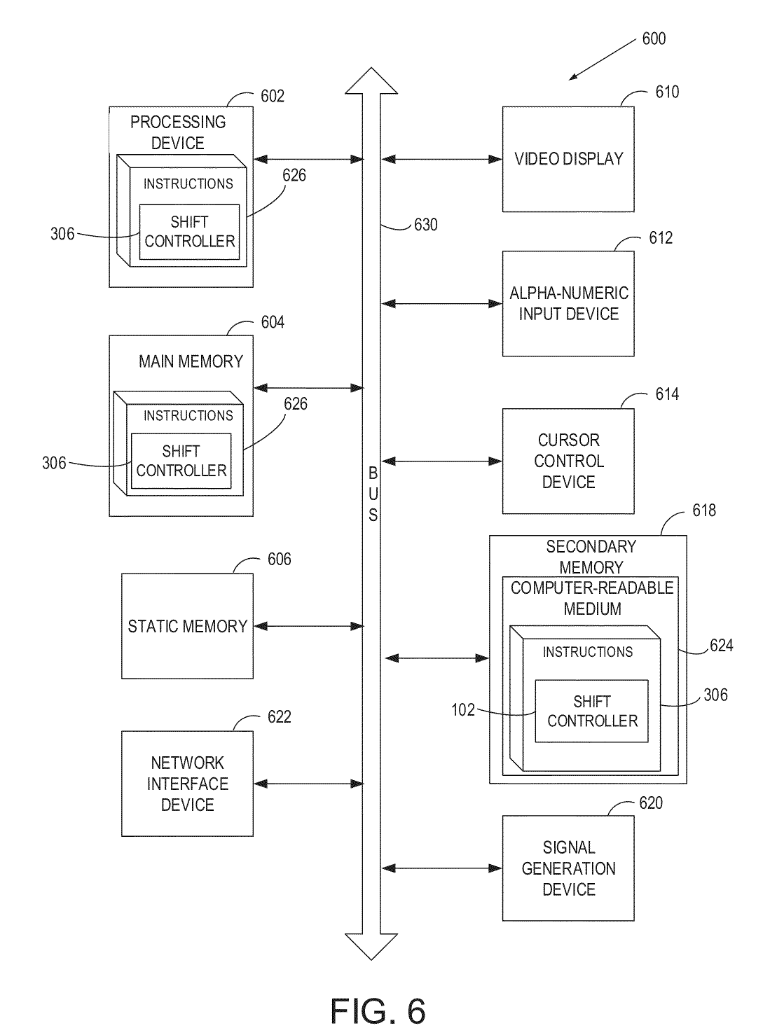

FIG. 6 is a diagram of one embodiment of a computer system for facilitating the execution of a shift indicator. Within the computer system 600 is a set of instructions for causing the machine to perform any one or more of the methodologies discussed herein. In alternative embodiments, the machine may be connected (e.g., networked) to other machines in a LAN, an intranet, an extranet, or the Internet. The machine can be a host in a cloud, a cloud provider system, a cloud controller or any other machine. The machine can operate in the capacity of a server or a client machine in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 600 includes a processing device 602, a main memory 604 (e.g., read-only memory (ROM), flash memory, dynamic random access memory (DRAM) such as synchronous DRAM (SDRAM) or DRAM (RDRAM), etc.), a static memory 606 (e.g., flash memory, static random access memory (SRAM), etc.), and a secondary memory 618 (e.g., a data storage device in the form of a drive unit, which may include fixed or removable computer-readable storage medium), which communicate with each other via a bus 630.

Processing device 602 represents one or more general-purpose processing devices such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the instructions 626 for performing the operations and steps discussed herein.

The computer system 600 may further include a network interface device 622. The computer system 600 also may include a video display unit 610 (e.g., a liquid crystal display (LCD) or a cathode ray tube (CRT)) connected to the computer system through a graphics port and graphics chipset, an alphanumeric input device 612 (e.g., a keyboard), a cursor control device 614 (e.g., a mouse), and a signal generation device 620 (e.g., a speaker).

The secondary memory 618 may include a machine-readable storage medium (or more specifically a computer-readable storage medium) 624 on which is stored one or more sets of instructions 626 embodying any one or more of the methodologies or functions described herein. In one embodiment, the instructions 626 include instructions for the shift controller 306. The instructions 626 may also reside, completely or at least partially, within the main memory 604 and/or within the processing device 602 during execution thereof by the computer system 600, the main memory 604 and the processing device 602 also constituting machine-readable storage media.

The computer-readable storage medium 624 may also be used to store the instructions 626 persistently. While the computer-readable storage medium 624 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

The instructions 626, components and other features described herein can be implemented as discrete hardware components or integrated in the functionality of hardware components such as ASICS, FPGAs, DSPs or similar devices. In addition, the instructions 626 can be implemented as firmware or functional circuitry within hardware devices. Further, the instructions 626 can be implemented in any combination hardware devices and software components.

In the above description, numerous details are set forth. It will be apparent, however, to one skilled in the art, that the present disclosure may be practiced without these specific details. In some instances, well-known structures and devices are shown in block diagram form, rather than in detail, in order to avoid obscuring the present disclosure.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “providing,” “generating,” “calculating,” “determining,” “querying,” “identifying,” “recording,” “maintaining,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

Reference in the description to “one embodiment” or “an embodiment” means that a particular feature, structure, or characteristic described in connection with the embodiment is included in at least one embodiment of the disclosure. The phrase “in one embodiment” located in various places in this description does not necessarily refer to the same embodiment. Like reference numbers signify like elements throughout the description of the figures.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. An apparatus comprising:
a memory to store instructions for providing a shift indicator; and
a computing device, coupled to the memory, wherein the computing device is configured to perform the steps of:
receiving a number of gears of a transmission of a vehicle,
determining a plurality of average revolutions per minute (“RPM”) to vehicle speed ratios for each of the gears of the transmission,
comparing a current RPM to vehicle speed ratio to the plurality of average RPM to vehicle speed ratios to determine a current gear, and
based on the current gear and a current RPM, indicating to a driver of the vehicle to shift the vehicle to a new gear.

2. The apparatus of claim 1, wherein the determining comprises repeating for each gear of the transmission the steps of:
monitoring, for a time period, the RPM of a motor and the vehicle speed; and
calculating the ratio of average RPM to average vehicle speed.

3. The apparatus of claim 2, wherein the time period is in the range of between about 1 and 10 seconds.

4. The apparatus of claim 2, wherein the time period is in the range of between about 3 and 7 seconds.

5. The apparatus of claim 1, wherein the receiving further comprises querying a vehicle engine control module for the number of gears.

6. The apparatus of claim 1, wherein the receiving further comprises receiving the number of gears from a user.

7. The apparatus of claim 1, wherein the comparing further comprises receiving the current RPM via an on-board diagnostic interface.

8. A method comprising:
receiving a number of gears of a transmission of a vehicle;
determining a plurality of average revolutions per minute (“RPM”) to vehicle speed ratios for each of the gears of the transmission;
comparing, via a processor, a current RPM to vehicle speed ratio to the plurality of average RPM to vehicle speed ratios to determine a current gear; and
based on the current gear and a current RPM, indicating to a driver of the vehicle to shift the vehicle to a new gear.

9. The method of claim 8, wherein the determining comprises repeating for each gear of the transmission the steps of:
monitoring, for a time period, the RPM of a motor and the vehicle speed; and
calculating the ratio of average RPM to average vehicle speed.

10. The method of claim 9, wherein the time period is in the range of between about 1 and 10 seconds.

11. The method of claim 9, wherein the time period is in the range of between about 3 and 7 seconds.

12. The method of claim 8, wherein the receiving further comprises querying a vehicle engine control module for the number of gears.

13. The method of claim 8, wherein the receiving further comprises receiving the number of gears from a user.

14. The method of claim 8, wherein the comparing further comprises receiving the current RPM via an on-board diagnostic interface.

15. A system comprising:
a housing comprising a shift indicator light, a memory, and a computing device;
where the memory is configured for storing instructions for controlling the shift indicator light; and
where the computing device, which is coupled to the memory, is configured to perform the steps of:
receiving a number of gears of a transmission of a vehicle,
determining a plurality of average revolutions per minute (“RPM”) to vehicle speed ratios for each of the gears of the transmission,
comparing, via a processor, a current RPM to vehicle speed ratio to the plurality of average RPM to vehicle speed ratios to determine a current gear, and
based on the current gear and a current RPM, indicating to a driver of the vehicle to shift the vehicle to a new gear.

16. The system of claim 15, wherein the determining comprises repeating for each gear of the transmission the steps of:
monitoring, for a time period, the RPM of a motor and the vehicle speed; and
calculating the ratio of average RPM to average vehicle speed.

17. The system of claim 16, wherein the time period is in the range of between about 1 and 10 seconds.

18. The system of claim 16, wherein the time period is in the range of between about 3 and 7 seconds.

19. The system of claim 15, wherein the receiving further comprises querying a vehicle engine control module for the number of gears.

20. The system of claim 15, wherein the comparing further comprises receiving the current RPM via an on-board diagnostic interface.
